(19) United States
(12) Patent Application Publication
(10) Pub. No.: US 2015/0215274 A1
(43) Pub. Date: Jul. 30, 2015

(54) DEVICE AND METHOD FOR GENERATING AN INTERNET PROTOCOL (IP) ADDRESS FROM A VEHICLE IDENTIFICATION NUMBER (VIN)

(71) Applicant: COMMISSARIAT A L'ENERGIE ATOMQUE AUX ENERGIES ALTERNATIVES, PARIS (FR)

(72) Inventors: Sofiane Imadali, Gif Sur Yvette (FR); Alexandru Petrescu, Orsay (FR); Christophe Janneteau, Chaudon (FR)

(21) Appl. No.: 14/414,118

(22) PCT Filed: Jun. 24, 2013
(86) PCT No.: PCT/EP2013/063126

§ 371 Date: Jan. 11, 2015

(30) Foreign Application Priority Data
Jul. 13, 2012 (FR) 1256772

(51) Int. Cl. H04L 29/12; H04L 29/08

(52) U.S. Cl. CPC H04L 61/2007; H04L 67/12; H04L 61/6068

(57) ABSTRACT

A device and a method are provided for generating IPv6 addresses from a vehicle identification number VIN. The method carried out by the communication controller of the vehicle is used inside the vehicle to generate unique local IPv6 addresses for the on-board devices. The method also enables the generation of IPv6 addresses for communication to the outside of the vehicle.

### FIELD OF THE INVENTION

The invention relates to the field of Internet Protocol (IP) communications and, in particular, IP addressing based on vehicle identification numbers (VIN).

### PRIOR ART

The increasing demand for communication creates requirements for connection from any mobile system to any fixed or mobile system. In particular, vehicles can be connected to other vehicles and/or to fixed stations. A vehicle is often equipped with a plurality of on-board computing and data transmission entities. An entity commonly referred to as a “communication controller” or router is responsible for communication with the outside of the vehicle. Connecting one vehicle to other vehicles, or to the Internet, creates addressing problems. It must be possible to generate an address for each interface of the communicating entities of a vehicle. For example, an on-board PC can use two interfaces, an Ethernet and a Wi-Fi interface. In this case, two addresses are required.

In order to implement communications by means of TCP/IPv6 protocols, an IP address is required for each of the interfaces of these entities. Each IP address must be unique, different from each of the other IP addresses of any other vehicular entity.

In order to avoid a costly dynamic address allocation process, it is desirable to be able to generate unique IP addresses locally. Address uniqueness is a fundamental characteristic in IP communications. Two devices having the same address cannot enter into communication.

The Internet Protocol version 6 (IPv6), also known by the name of “Internet Protocol next generation” (IPng), is the successor to the Internet Protocol version 4. IPv6 specifies the procedures that are required for exchanging data packets via packet-switching networks, for addressing the elements involved in the routing of the packets (computers and routers), and also the procedures for transferring the packets from one subnetwork to another (routing). The IPv6 protocol is a standard defined by the Internet Engineering Task Force (IETF) and taking place in layer 3 (network layer) of the OSI model.

IPv6 addresses are 128-bit identifiers, the addressing architecture, types and format of which are defined in the IETF standard [RFC 4291]. The IETF document [RFC 2464] describes the transmission of the IPv6 packets in Ethernet networks and specifies the structure of the IPv6 address, in particular the part referred to as the “Interface Identifier” (IID), written according to the “Extended Unique Identifier” (EUI-64) format. The IETF document [RFC 4861] defines the “Neighbor Discovery” protocol for IPv6, in particular the specification of the “Router Advertisement” which enables the dissemination among the network hosts of the information giving the configuration of different IPv6 parameters of the link (prefix, default router, MTU (maximum Transmission Unit), etc.).

The IETF document [RFC 4193] defines a method for the creation of globally unique unicast IPv6 addresses with a global range, but the use of which must be limited to one site. The addresses generated by this method are referred to as “Unique Local IPv6 Unicast Addresses” (ULA). Inter-site communications are possible, provided that the number of sites is small. This method enables the formation of communicating sites independent from the Internet access providers (IAP) for the allocation of their prefixes. A ULA address is formed according to the format shown in FIG. 1, which includes the following fields:
Prefix: fixed at “FC00::/7” to identify a ULA address.
L: fixed at 1 if the prefix is assigned locally.
Global ID: 40-bit identifier, used to create globally unique prefixes generated by a pseudorandom algorithm.
Subnet ID: Identifies a subnetwork in the site. It is possible to create 65,536 subnetworks for a single created global ID identifier.
Interface ID: this being the 64 bits defined for the creation of addresses in IPv6.

A unique prefix for each IPv6 address used inside the vehicle can be obtained from an external system, which entails an administrative assignment followed by automated distributions. Administratively, it is possible to assign unique IPv6 addresses by way of a central allocation body such as the “IANA” (Internet Assigned Number Authority with these representatives: in Europe Ripe, ARIN in America, etc.). The administrative distribution can then be implemented by automated means such as the allocation by a fixed base station to a particular vehicle, by using, for example, the DHCPv6 protocol [RFC 3315] with “Prefix Delegation” extensions [RFC 3633]. The prefixes thus administratively assigned to the fixed network of the base stations, then dynamically allocated by the DHCPv6 Prefix Delegation protocol, will finally be announced inside the vehicle by “Router Advertisement” messages [RFC 48612]. However, these methods do not guarantee retention of the same addresses following a switchover due to mobility, for example during a change of fixed base station. In order to overcome this problem, it is possible to use the protocols from the Mobile IPv6 family [RFC 6275] with mobility extensions for mobility of the NEMOv6 networks [RFC 3963] in order to continue to use addresses assigned to a vehicle by a first base station. However, this method imposes the use of a fixed communication infrastructure with the fixed base stations deployed on a large scale, and areas currently exist which are not covered by such stations in which it is, however, necessary to communicate between vehicles, without the aid of a base station connected to the Internet.

A further disadvantage of this method is the fact that the uniqueness of IPv6 addresses is guaranteed only by the initial administrative assignment, by a central body. For an automobile manufacturer, this operation of interacting with RIPE can take time. Furthermore, this assignment would be an operation in addition to the VIN assignment operation (WMI (World Manufacturer Identifier) part) by the SAE (Society of Automotive Engineers) to automobile manufacturers.

Furthermore, solutions exist for using the vehicle identification number (VIN), which is a unique identifying number of a vehicle, for the generation of one or more IP addresses inside a vehicle.

The VIN being unique, a direct conversion of the VIN to the format of the IP addresses gives a unique IP identifier. However the VIN-IP conversion imposes constraints, in particular for the IPv6 protocol where the addresses are 128-bit coded, in fact:
A VIN is represented by 17 alphanumeric characters. An alphanumeric character (digit) can typically be represented by 8 bits. A direct and straightforward conversion of the VIN substantially exceeds the 128 bits available in an IPv6 address.
A straightforward conversion of a VIN to a single complete IPv6 address (128 bits) is not sufficient to address individually a plurality of on-board devices.
A conversion through “hashing” consisting in applying a typical cryptographic function provides unique results of a short length. However, the hashing methods are not bijective, and it is impossible to retrieve parts of the VIN from the corresponding IPv6 address. This approach reduces its field of application, since it excludes certain typical applications of the automotive field, such as, for example, the identification of certain characteristics of the vehicle having sent a particular message (place of manufacture, year of manufacture, or the like) from the IPv6 address.

The U.S. Pat. No. 7,917,603 of Byeong-Woo et al. proposes a method for creating an IPv6 address from the vehicle identification number (VIN). Certain characteristics of the VIN are extracted and converted according to a mapping algorithm to create the lower part of an IPv6 address (the Interface Identifier). However, all the characters of the VIN are not used, such as, for example, the digit describing the production site, also referred to as the “manufacture”. Two similar vehicles of the same model, produced in the same year in two different manufactures and having the same serial number (unique in the same manufacture, but not within the manufacturing company) will generate the same IPv6 address, resulting in an addressing conflict.

Roland Bless (Institute of Telematics Karlsruhe Institute of Technology (KIT)) in “A Secure IPv6-based Architecture for Internal Automotive Networks”, presented at the IETF-83 meeting in Paris on Mar. 26, 2012, proposes to use the VIN as a unique identifier of a vehicle in a vehicle in a pseudorandom ULA prefix generation algorithm. In this method, based on the algorithm described in the IETF document [RFC 4193] (section 3.2.2), a prefix collision probability exists which remains significant in contexts requiring the management of a large number of vehicles within the same manufacturing company. Moreover, this approach does not specify the generation of complete addresses with a length of 128 bits. Finally, this method offers a one-way conversion method. An IPv6 ULA prefix is generated from a particular VIN. The reverse conversion, from this prefix P to the particular VIN code, is impossible.

The need therefore exists for a solution which overcomes the disadvantages of the existing approaches. The present invention meets this need.

### SUMMARY OF THE INVENTION

One object of the present invention is to provide a method for establishing unique IPv6 addresses on the basis of a VIN.

Another object of the present invention is to generate a prefix for a set of addresses, valid for the communicating entities on board the same vehicle.

The method according to the invention advantageously offers a guarantee of address uniqueness, derived from the use of a large number of fields of the VIN and the simultaneous use of the prefix and the Interface identifier.

The present invention advantageously proposes a method for generating IPv6 addresses which does not use a random generation mechanism and provides a better guarantee of address uniqueness.

The present invention advantageously proposes a two-way address generation method which converts a VIN to addresses, and also the reverse possibility, of retrieving certain parts of the VIN used in the generation of a particular address.

The method according to the invention advantageously allows the implementation of new applications such that, for example, a server in a fixed infrastructure, receiving packets from vehicles, can identify the precise location of manufacture of the vehicle, simply by consulting the source address of the packets.

The method according to the present invention advantageously allows each vehicle to generate autonomously a unique IPv6 prefix. It can thus be used within a fleet of vehicles such as, for example, all the vehicles of the same manufacturer.

In the context of use within a fleet operator, the method according to the invention allows each vehicle in the fleet to autonomously generate a unique IPv6 prefix routable within a restricted routing range, such as the network domain of the fleet operator. The method according to the invention advantageously allows a fleet operator to avoid having to explicitly allocate a prefix routable on the scale of the Internet to each vehicle.

The method according to the invention thus offers gains in terms of:
resources, through routable address economies;
simplicity, thanks to a local auto-configuration (not requiring additional interaction with a central assignment body such as RIPE);
security, the generated prefix being routable in the fleet operator's domain, thus preventing any access to the IPv6 devices of the vehicles from outside the operator's domain.

The prefixes generated by the method according to the invention can advantageously be used to support any type of communication between the vehicles of the manufacturer's fleet or with the fleet operator's servers, regardless of whether the communications are routed via the fleet operator's infrastructure (Vehicle-to-Infrastructure or V2I), or are routed directly between vehicles (Vehicle-to-Vehicle or V2V) by a local radio connectivity without support on a fixed communication infrastructure.

The present invention will advantageously be used in applications for automobile manufacturers, vehicle fleet operators, for example vehicle leasing agencies or any company having a vehicle fleet for remote diagnosis, remote maintenance or other applications.

In order to obtain the desired results, a method is proposed for generating Internet Protocol (IP) addresses for entities connected to a communication controller via a network within a vehicle, the vehicle being associated with a vehicle identification number (VIN). The method includes the steps of:
encoding the content of one or more fields of the VIN in the decimal base and the content of one or more other fields of the VIN according to a non-random algorithm;
converting the result of the encoding into binary;
ordering the bits obtained according to a predefined sequence;
generating an interface identifier (IID) and an IP address prefix from the ordered sequence; and
constructing an IP address for each entity, each IP address including at least said generated prefix.

Different alternative embodiments are described in the dependent claims.

### DESCRIPTION OF THE FIGURES

Different aspects and advantages of the invention will become evident from the description of a preferred, but non-limiting, embodiment of the invention, with reference to the figures below:

FIG. 1 shows the format of a ULA address;

FIG. 2 shows an example of a vehicle identification number (VIN);

FIG. 3 is a simplified view of the VIN-IPv6 address conversion method according to the invention;

FIG. 4 shows an environment in which to implement the present invention;

FIG. 5 shows the formats of the objects obtained by the method according to the invention.

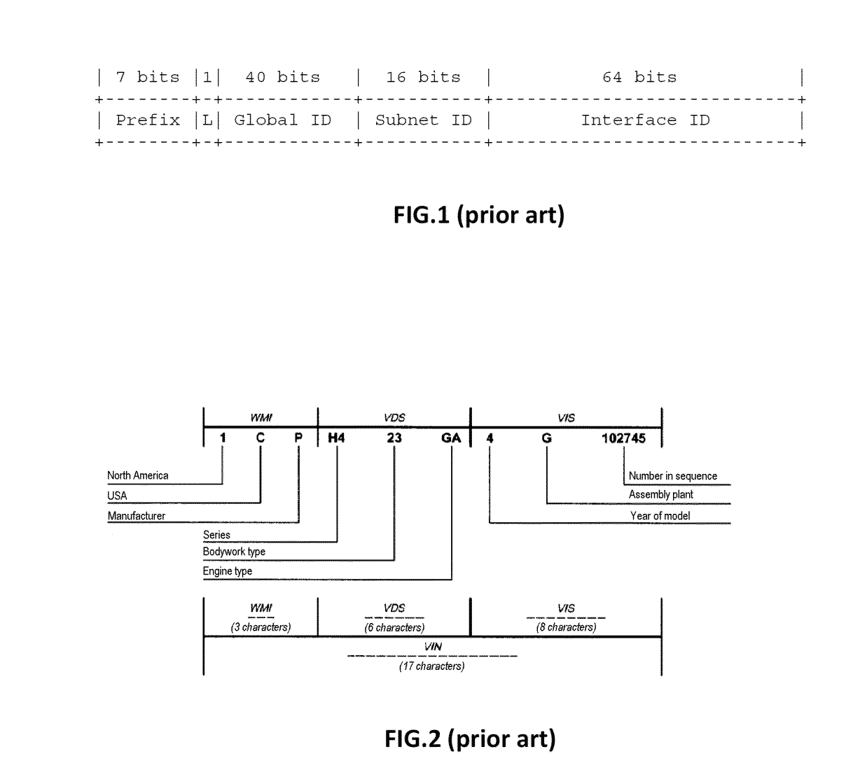

### DETAILED DESCRIPTION OF THE INVENTION

FIG. 2 shows an example of a vehicle identification number VIN, as referenced in the document ISO-3779-2009. The “International Standards Organization” (ISO) defines the standards ISO 3779 “Vehicle identification number (VIN), content and structure” and ISO 3780 “Road vehicles. World manufacturer identifier (WMI) code”. The document ISO 3779 specifies the content and structure of a vehicle identification number (VIN) providing, on a worldwide scale, a uniform numbering system for identifying road vehicles. The document ISO 3780 specifies the content and structure of a code providing, on a worldwide scale, the identification of the manufacturers of road vehicles.

The “World Manufacturer Identifier” (WMI) code forms the first section of the vehicle identification number (VIN) defined in ISO 3779.

The standard describes a distinctive encoding of the different fields of the “Vehicle Identification Section” (VIS) according to the number of vehicles produced per annum, the criterion being below or above the limit threshold of 500 produced vehicles. For reasons of simplification of the description and not functionality, the following description considers an encoding for manufacturers producing more than 500 vehicles per annum, as in the VIS encoding example shown in FIG. 2.

However, the person skilled in the art will appreciate that the method described also works using VIS encoding of manufacturers producing fewer than 500 vehicles per annum.

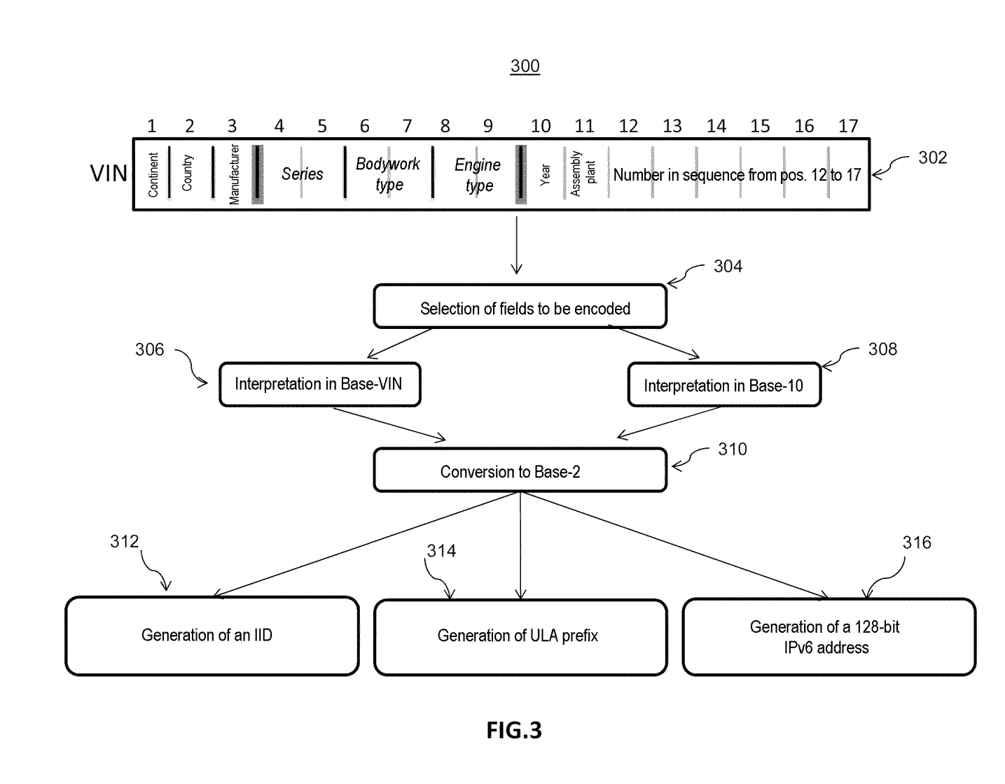

FIG. 3 is a simplified view of the VIN/IPv6 address conversion method (300) according to the invention.

FIG. 3 is also described with reference to FIG. 5, which shows the format of the objects obtained by the method according to the invention. At the input, the method receives (302) a VIN number (502). In the following step (304), the method carries out a selection of fields to be encoded from the set of fields of the VIN. The selection of the fields is carried out in such a way as to guarantee a maximum of uniqueness.

The fields are advantageously selected from each of the three sections (WMA, VDS, VIS) of the VIN, according to particular characteristics of field meanings. The semantic meaning of each field is a particular feature which makes it more or less useful for the creation of the unique identifiers. For example, the fields ‘Manufacturer’ (position 3 of the “WMI) or ‘Year of Model’ (10^{th} position of the VIS) which are defined in the same way for all particular cases and have the same meaning for the representations distinguished by the threshold of 500 vehicles manufactured per annum, are fields which can be selected as unique identifiers. However, the person skilled in the art will be able to apply the selection to other fields in order to apply the principle of the invention. Conversely, fields such as ‘Bodywork Type’ (positions 6 and 7 of the VDS) are not good candidates since, for a manufacturer below the 500-vehicle threshold, its meaning changes (and becomes ‘Mass all Taken Up’).

In a preferred embodiment, all fields of the “World Manufacturer Identifier” (WMI) section represented in the VIN over 3 positions are selected, all fields of the “Vehicle Identification Section” (VIS) are selected, and some fields the “Vehicle Description System” (VDS) section are selected. Positions 4 and 5 which represent the ‘series’ field over 2 digits in the VIS section are advantageously selected.

In a next step, the selected fields are interpreted (306, 308). Among the selected fields, some are interpreted in a new base referred to as “base-VIN” (306), while others are interpreted in base-10 (308). This differentiated interpretation allows a reduction in the size of the object generated by the conversion.

The base-VIN developed for the present invention contains characters necessary for the creation of a VIN and suitable for conversion operations to a decimal base and vice versa.

A conversion from the decimal base to the binary or hexadecimal base is advantageously also possible.

The numbers of the base-VIN can be added, subtracted, multiplied, divided and converted from one base to another.

The base-VIN contains 33 distinct and ordered characters. The value of each of these characters, represented in the decimal base, ranges from 0 to 32. The symbols used are those of the VIN description of the ISO/IEC document 3779: 2009, “Vehicle identification number (VIN), content and structure”, October 2009 and ordered according to the following list: 0, 1, 2, 3, 4, 5, 6, 7, 8, 9, A, B, C, D, E, F, G, H, J, K, L, M, N, P, R, S, T, U, V, W, X, Y, Z.

The conversion from the decimal base to base-VIN is carried out according to the following steps, where it is assumed that ‘X’ is a decimal number and ‘Y’ is the result of its conversion to base-VIN.

1. Divide X by 33, as an integer. As long as the quotient is greater than 33, continue to divide X by 33.

2. Note the Remainder and convert it to base-VIN according to the rules of equivalence.

3. Stop the division when the quotient is less than 33, and write it in base-VIN.

4. Read the result Y from the end to the beginning, taking the first division remainder as the least significant bit, after conversion to base-VIN, and the last quotient as the most significant bit, following conversion to base-VIN. The result Y is written in base-VIN.

For illustration, the conversion of the number X=1200 from decimal to base-VIN by following the steps described above gives Y=13C. The notation “a/b=c+d [b]” means below that “c” is the quotient of the division of “a” by “b” and “d” is the remainder.

1) 1200/33=36+12 [33]. 12 is therefore the first remainder. Its equivalent in base-VIN is C.

2) 36 is greater than 33, so the algorithm continues.

3) 36/33=1+3 [33]. 3 is the second remainder. Its equivalent in base-VIN is 3.

4) 1 is less than 33, which stops the execution of our algorithm. 1 is equal to 1 in base-VIN.

5) The final result at the end of the conversion is therefore ‘130’.

The reverse conversion, from base-VIN to the decimal base, is carried out according to the following steps. The algorithm is similar to the conversion from a base B (hexadecimal or binary, for example) to the decimal base, except that the base is 33 in decimal. It is assumed below that ‘X’ is a number in base-VIN and ‘Y’ is the result of its conversion to the decimal base. Moreover, ‘n’ represents the number of positions in ‘X’, ‘i’ represents a counter and ‘X(i)’ returns the number in base-VIN to the position ‘i’ of ‘X’.

Y=0;

For i ranging from (n−1) to 0, calculate:

Y=Y+((X(i+1))*(33̂i))

For illustration, the conversion of the number ‘13C’ written in base-VIN to the decimal base, by running the preceding algorithm, gives Y=1200:

X=13C, n=3, LSB=C and MSB=1, where LSB means the “Least Significant Bit”, and MSB means the “Most Significant Bit”.

Y=1*(33̂2)+3*(33̂1)+C*(33̂0)

Y=1*(1089)+3*(33)+12*(1)

Y=1200

The initial result of the previous example of the conversion from decimal to base-VIN is thus retrieved.

To return to step (306, 308), the selected fields of the WMI, VDS and some fields of the VIS are interpreted in base-VIN, while the other fields are interpreted in base-10.

The person skilled in the art will appreciate that, in one variant in which all fields are interpreted in base-10, or in a variant in which all fields are interpreted in base-VIN, the resulting object is encoded using a larger number of bits in the preferred embodiment in which the fields are interpreted in a differentiated manner in mixed bases. In fact, as it is known that the position 10 of the VIN which comprises 1 digit may contain only 30 distinct values, an interpretation of this position in any bases other than the base-VIN would give longer results.

The WMI section comprising 3 digits is advantageously interpreted in base-VIN, positions 4 and 5 of the VDS are interpreted in base-VIN, position 10 of the VIS section is interpreted in base-10, positions 11, 12, 13 of the VIS section are interpreted in base-VIN, and positions 14, 15, 16 and 17 of the VIS are interpreted in base-10.

The fields interpreted in the base-VIN and base-10 are converted into binary (base-2) in a next step (310).

The WMI field is converted into binary to generate a 16-bit object. Position 10 of the VIS is converted into binary to generate a 5-bit object. Positions 11, 12, 13 of the VIS are converted into binary to generate a 16-bit object. Positions 14, 15, 16, 17 of the VIS are converted into binary to generate a 14-bit object.

The result of the binary conversions is stored in an intermediate form representing a 51-bit ordered sequence (510). The intermediate object obtained is unique and is used in following steps (312, 314, 316) to generate three entities:
an IPv6 address interface identifier (IID) (512);
a ULA prefix (514); and
a complete IPv6 address (516).

The IID (512) which is generated from the 51 bits of the ordered sequence obtained in step 310 has a length of 64 bits. This identifier is used by the communication controller of the vehicle to form a complete IPv6 address on its communication interface(s) for communications to the outside of the vehicle. The prefix of the external address thus formed can be obtained from an external system by a known auto-configuration or “stateless” method.

The generated ULA prefix (514) contains at least the 51 bits of the intermediate object obtained in step 310. The interface identifier and the ULA prefix are constructed from the same 51 bits of the intermediate object. The ULA prefix is 59-bit coded. This prefix can be used inside the vehicle by each of the devices that are compatible with the TCP/IPv6 protocol to form unique IPv6 addresses for each device. A TCP/IPv6 device inside the vehicle generates its own interface identifier using a standard method, such as, for example, from the MAC address of its interface, as described by M. Crawford, “Transmission of IPv6 Packets over Ethernet Networks”, IETF RFC 2464, December 1998.

In a preferred embodiment, the ULA prefix is generated by concatenating the fields of:
7 bits whose value is 1111110;
1 bit whose value is 1;
51 bits whose value is that of the intermediate form.

The generated IPv6 ULA prefix can be announced by the communication controller inside the vehicle using, for example, “Router Advertisement” messages. The devices inside the vehicle, by receiving this prefix, can use other existing means for forming an Interface Identifier (from the MAC address, for example) and can concatenate it with this prefix, in such a way as to form unique and local IPv6 addresses based on this prefix.

In one variant, a different use of the ULA prefix is possible: the controller can use the DHCPv6 protocol to form complete addresses for the devices inside the vehicle, addresses based on this prefix and of which the Interface Identifier would follow an arbitrary rule, for example 1, 2, 3, . . . .

Optionally, it may be desirable in some scenarios, such as, for example, for reasons of “privacy”, to ensure that information from the VIN stored in the 51 bits is not immediately readable, and to mask it in order to then retrieve it in the IPv6 prefix. To do this, it is possible to use an injective and not easily invertible function which will ensure that, for any unique 51-bit set given at the input of this function, the latter supplies at the output a unique 51-bit set differing from the input. Such a function may, for example, be an asymmetric encryption function, encryption of the 51 input bits on the basis of a public key and providing a 51-bit result.

The communication controller also uses the interface identifier (512) and the ULA prefix (514) generated from the VIN to form a complete IPv6 address (516) assigned to its internal interface(s) within the vehicle.

Thus, the method according to the invention enables a set of unique IPv6 addresses to be generated from the VIN of the vehicle. The generated addresses are unique for all the vehicles carrying out the method according to the invention.

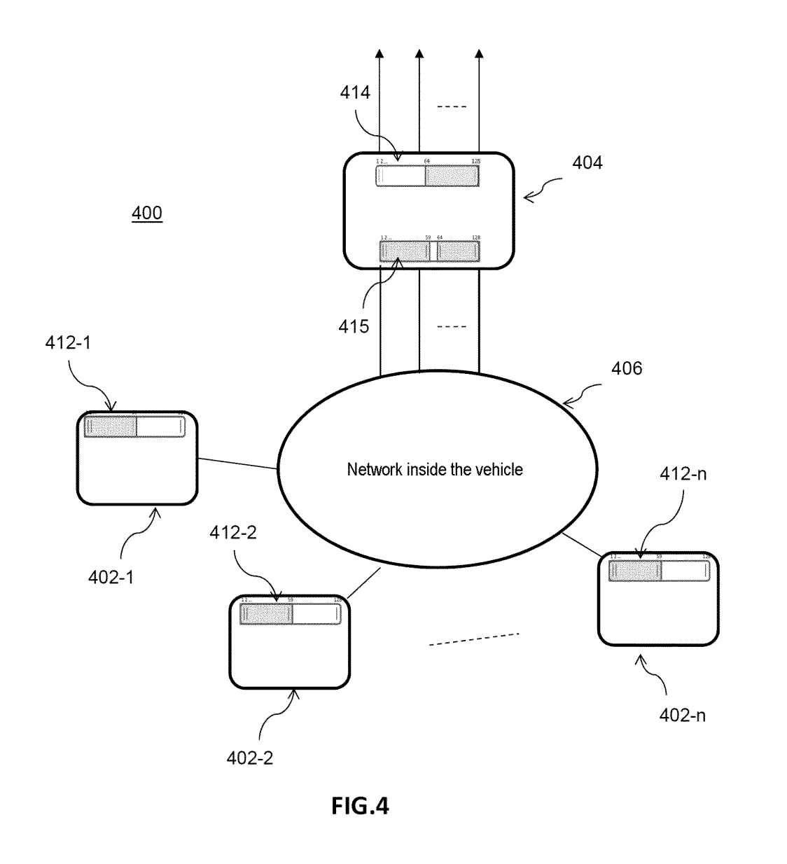

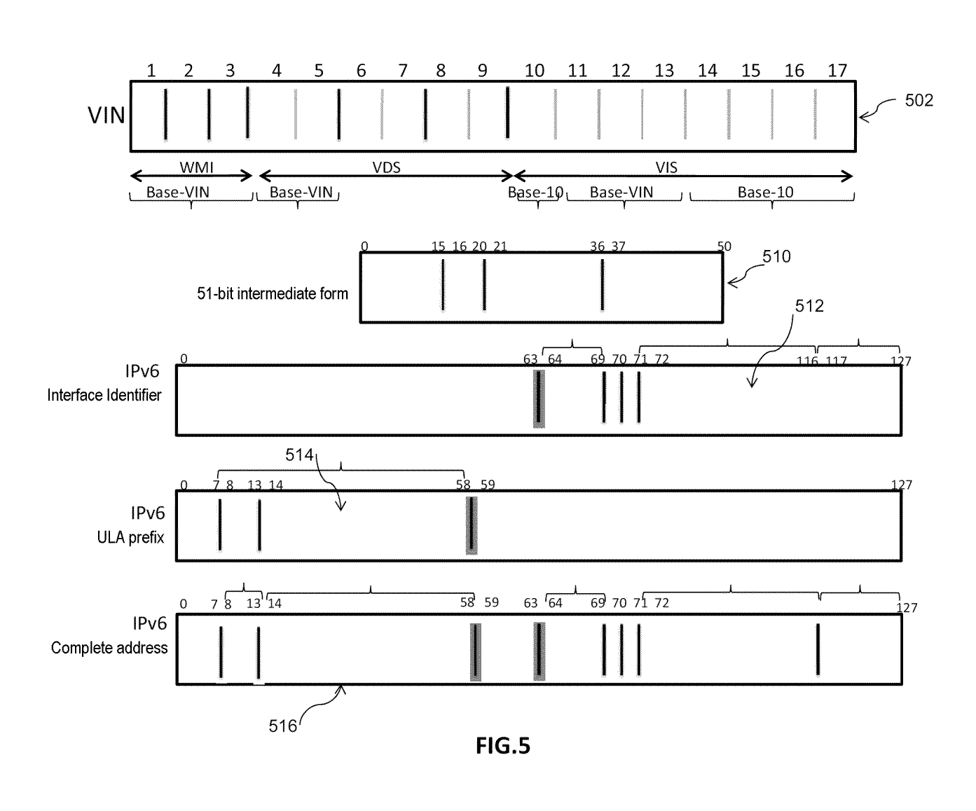

FIG. 4 shows the environment 400 for a vehicle in which to implement the present invention. A vehicle includes a plurality of communicating on-board devices (402-1, 402-2, . . . , 402-n) connected to a router or communication controller (404) via a communication network (406) within the vehicle.

Each device has a communication interface (412-1, 412-2, 412-n) based on the VIN of the vehicle according to the principle of the present invention.

Other devices compatible with the TCP/IPv6 protocol can be installed on board, each communication interface of which can use IPv6 addresses whose prefix is determined from the VIN of the vehicle and whose interface identifier is determined by a different system, such as, for example, from the MAC address of the device interface.

The communication controller (404) has one or more external interfaces (414) for communicating with the outside of the vehicle and one or more internal interfaces (415) for communicating with the on-board entities.

On the external interfaces (414), IPv6 addresses whose prefix is provided by a system outside the vehicle as described above are used. The interface identifier is determined from the VIN of the vehicle using the method according to the invention. The following positions of the complete external address of the external communication controller are advantageously generated as follows:
Positions 0 to 63 of the IPv6 address which represent a prefix are determined by external means such as, for example, by a “Router Advertisement” message containing a unique global prefix, sent by a system outside the vehicle, by a fixed base station or another vehicle;
The first 6 bits positioned from 8 to 13 in the ULA prefix are copied into the first 6 bits of the Interface Identifier at positions 64 to 69;
Bit 70 which is a standardized bit known as “Universal/Local” (U/L) is set to 1;
The bit in position 71 which is standardized, known as “Individual/Group” (g) is set to 0 to indicate that it is an individual address, not a group address;
Positions 72 to 116 are copied from positions 14 to 58 of the ULA prefix;
Positions 117 to 127 are determined as follows:
   if the communication controller has only one external interface, then:
      positions 4 and 5 of the VDS section of the VIN (typically “engine type”) are interpreted in base-VIN and the result is converted into binary giving 11 bits;
   if the communication controller has a plurality of external interfaces, then:
      the 11 least significant bits of the “Interface Index” are used. The Interface Index is a value present for each operating system which runs on communication controller machines representing the current interface. For example, for number 1 interface, the value is “1”. The Index Interface is typically represented over 16 bits.

On the internal interfaces (415) of the communication controller, IPv6 addresses whose prefix and interface identifiers are determined from the VIN of the vehicle according to the method of the invention are used.

A complete IPv6 address for use inside the vehicle by the controller is constructed as follows:
the bits in positions 0 to 8 are those of a ULA (fc00:: /7 and 8^{th} bit L to 1);
positions 9 to 14 are determined from positions 64 to 69 of the Interface Identifier previously constructed;
positions 15-59 correspond to positions 72-116 of the IID;
positions 60-63 are set to 0;
positions 64-69 of the complete address correspond to positions 64-69 of the Interface Identifier previously constructed;
position 70 (interpreted inverted meaning “Global”) is set to 0;
position 71 is set to 0, to indicate an individual address and not a group address;
positions 72-116 correspond to positions 72-116 of the Interface Identifier previously constructed;
positions 117-127 are defined as follows:
   if the communication controller has a single internal interface, then:
      positions 4 and 5 of the VDS section of the VIN (typically “engine type”) are interpreted in base-VIN and the result is converted into binary giving 11 bits;
   if the communication controller has a plurality of external interfaces, then:
      the 11 least significant bits of the Index Interface are used.

These complete IPv6 addresses, once constructed, are used directly on one or more internal interfaces of the communication controller.

The person skilled in the art will appreciate that variations can be applied to the method as described in a preferential manner, while maintaining the principles of the invention.

The present invention can be implemented on the basis of hardware and/or software elements. It can be available as a computer program product on a computer-readable medium. The medium may be electronic, magnetic, optical, electromagnetic, or may be an infrared broadcast medium. Such media are, for example, semiconductor memories (Random Access Memory RAM, Read-Only Memory ROM), tapes, diskettes or magnetic or optical disks (Compact Disk-Read Only Memory (CD-ROM), Compact Disk-Read/Write (CD-R/W) and DVD).

Thus, the present description illustrates a preferred embodiment of the invention but is not limiting. An example has been chosen to allow a good understanding of the principles of the invention and a specific application, but it is by no means exhaustive and must enable the person skilled in the art to make modifications and alternative embodiments while maintaining the same principles.

1. A method for generating Internet Protocol (IP) addresses for entities connected to a communication controller via a communication network inside a vehicle, the vehicle being associated with a vehicle identification number (VIN), the method comprising the steps of:
encoding the content of one or more fields of the VIN in the decimal base and the content of one or more other fields of the VIN according to a non-random algorithm;
converting the result of the encoding into binary;
ordering the bits obtained according to a predefined sequence;
generating an interface identifier (IID) and an IP address prefix from the ordered sequence; and
constructing an IP address for each entity, each IP address including at least said generated prefix.

2. The method as claimed in claim 1, further comprising a step of sending a message to the entities of the vehicle to announce said prefix.

3. The method as claimed in claim 1 wherein the IP address constructed for each entity further includes an interface identifier based on the MAC address of each entity.

4. The method as claimed in claim 1, further comprising, before the encoding step, a step of selecting the fields of the VIN to be encoded.

5. The method as claimed in claim 4 wherein the selection step consists in selecting all the fields of the “World Manufacturer identifier” (WMI) section, all fields of the “Vehicle Identification Section” (VIS), and one or more fields of the “Vehicle Description System” (VDS) section.

6. The method as claimed in claim 5, wherein positions 4 and 5 of the VDS section are selected.

7. The method as claimed in claim 5, wherein the encoding step consists in encoding in the decimal base positions 10, 14, 15, 16 and 17 of the VIS section.

8. The method as claimed in claim 1, wherein the ordered sequence contains 51 bits.

9. The method as claimed in claim 1, further including a step of constructing at least one IP address for the communication controller, said at least one IP address including said interface identifier and at least one prefix generated by a system outside the internal communication network of the vehicle.

10. The method as claimed in claim 1, further comprising a step of constructing at least one IP address for the communication controller, said at least one IP address including at least said interface identifier and said prefix.

11. The method as claimed in claim 1, wherein the IP addresses are IPv6 addresses, and said prefix is a ULA prefix.

12. A system for generating Internet Protocol (IP) addresses for entities connected to a communication controller via a communication network within a vehicle, the vehicle being associated with a vehicle identification number (VIN), the system including means for carrying out the steps of the method as claimed in claim 1.

13. The system as claimed in claim 12, wherein the entities are suitable for communicating according to the TCP/IPv6 protocol and the generated addresses are IPv6 addresses.

14. The system as claimed in claim 12, wherein the communication controller includes internal interfaces and external interfaces to communicate on the generated IP addresses as claimed in any one of claims 1 to 11.

15. A computer program product, said computer program including code instructions enabling the steps of the method as claimed in claim 1 to be carried out, when said program is executed on a computer.
